(19) United States
(12) Patent Application Publication
(10) Pub. No.: US 2015/0360364 A1
(43) Pub. Date: Dec. 17, 2015

(54) Tool Board

(71) Applicant: Darren Scott Douglas, Gardner, KS (US)

(72) Inventor: Darren Scott Douglas, Gardner, KS (US)

(21) Appl. No.: 14/304,299

(22) Filed: Jun. 13, 2014

(51) Int. Cl. B25H 3/04; B65D 25/28; B65D 25/22

(52) U.S. Cl. CPC B25H 3/04; B65D 25/22; B65D 25/28

(57) ABSTRACT

Removable Tool Board (TB) for storing, transporting and accessing items of any kind.

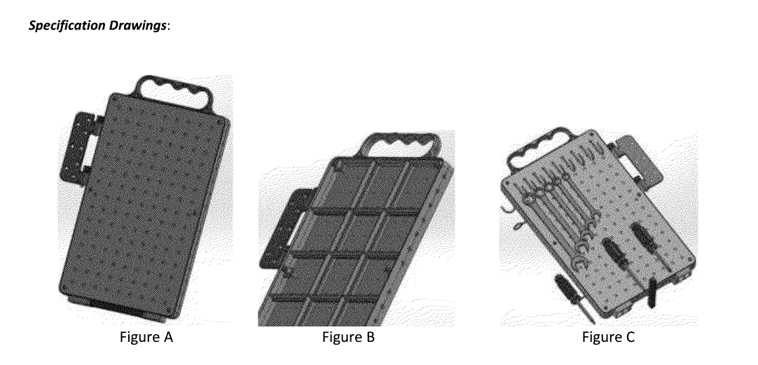

The TB has a handle and a hinge system. The male half of the hinge is vertically mounted to a surface by the user that allows the female half of the hinge on the TB to rotate freely on the male half of the hinge. Rotation of the TB allows easy access of items stored on both sides of the TB.

The TB can be lifted off the surface mounted hinge-half to be transported to other locations.

The TB has a foot that can rotate parallel with the TB or perpendicular with the TB, making the TB self-standing.

The foot rotates on a centered pin; locking into position when it is turned parallel with the TB.

Any hardware product made of any material can be used on the TB for storing items.

Removable board made of any type of material for storing, transporting and accessing items of any nature; such as, but not limited to, tools (wrenches, pliers, drivers, etc.), hair salon items (brushes, scissors, clips, etc.), kitchen utensils (knives, spatulas, whisks, etc.), etc. The Tool Board may be made of multiple sizes per its intention of use.

The Tool Board has a hinge system. The male half of the hinge is to be vertically mounted to a surface by the end user customer that allows the female half of the hinge that is a part of, or attached to, the Tool Board to hang and swing freely on the male half of the hinge. Rotation of the Tool Board on the hinge allows easy access of items stored on both sides, and possibly two edges, of the Tool Board.

The Tool Board has a carrying handle. At any time, the Tool Board can be lifted off the surface mounted hinge half to be transported to other locations with items still attached to the Tool Board.

At the bottom of the board there is a foot, or feet, mechanism that can positioned so as to become perpendicular with the Tool Board, making the Tool Board self-standing when removed from the surface mounted hinge. The foot, or feet, mechanism can, also, be positioned in parallel with the Tool Board for the purpose of not being in the way when the Tool Board is hung on the male half of the surface mounted hinge. The foot, or feet, rotate freely on a centered pin; snapping into a locked position when it is turned parallel with the Tool Board.

Any hardware product made of any material can be used on the Tool Board for storing items; hardware, such as, but not limited to, hooks, eye anchors, pegs, magnets, etc., that could hook, snap or screw into the appropriate peg board of the Tool Board. The hardware may be easily installed and re-installed by the end user customer for the purpose of customizing the organization of their items.

### BRIEF DESCRIPTION OF DRAWING

The first image (A) is an example of a Tool Board without the hardware used for storing items, the full hinge, and the foot on the bottom of the Tool Board in the closed position.

The partial image (B) depicts one side of the peg board removed for the sake of a visual description of how the peg board, made of any material, can be attached to the Tool Board.

The image (C) shows an example of hardware and items attached to the Tool Board, as well as, the foot in the open position so the Tool Board can be self-standing (though not displayed as standing for the sake of a better visual of the open foot).

1. The Tool Board stores items on multiple sides of the Tool Board.
With compliance to Claim A, where in Claim B the Tool Board uses a hinge to hang from a vertical surface allowing access to both sides of the Tool Board.
With compliance to Claim A and B, where in Claim C the Tool Board uses a hinge that allows the Tool Board to be easily attached to, removed from, and re-attached to the vertical surface.
With compliance to Claim A thru C, where in Claim D the Tool Board is portable.
With compliance to Claim A thru D, where in Claim E the Tool Board has a pivoting foot for the board to be self-standing when the Tool Board is removed from the vertical surface.
With compliance to Claim A thru E, where in Claim F the Tool Board is made of plastic, and/or wood or wood composite, and/or any type of metal or metal composite.
With compliance to Claim A thru F, where in Claim G the Tool Board has a handle for carrying the Tool Board.
With compliance to Claim A thru G, where in Claim H the hardware on the Tool Board used for storing items may be made of plastic, and/or metal or metal composite, and/or magnetic material.
With compliance to Claim A thru H, where in Claim I the Tool Board hardware may be installed, repositioned, or removed by the consumer.
